(19) United States
(12) Patent Application Publication
(10) Pub. No.: US 2008/0133608 A1
(43) Pub. Date: Jun. 5, 2008

(54) SYSTEM FOR AND METHOD OF MANAGING WORKLOADS IN A DATABASE SYSTEM

(76) Inventors: Douglas Brown, Rancho Santa Fe, CA (US); Choung Kim, Torrance, CA (US); Anita Richards, San Juan Capistrano, CA (US)

Correspondence Address: James M. Stover;Intellectual Property Section, NCR Corporation, 1700 South Patterson Blvd., Dayton, OH, 45479, US

(21) Appl. No.: 11/566,734

(22) Filed: Dec. 5, 2006

(51) Int. Cl. G06F 17/30

(52) U.S. Cl. 707/200; 707/E17.005

(57) ABSTRACT

A system for and method of managing database workloads. The workload managing system comprises a historical data collector arranged to collect historical data indicative of historical database performance trends, and a current data collector arranged to collect substantially current data indicative of substantially current database performance. The system is arranged to compare the collected historical data with the collected substantially current data and to modify operation of the database based on the comparison.

### FIELD OF INVENTION

This application is related to copending application No. 10/889,796, the contents of which are hereby incorporated by reference. The present invention relates to a system for and method of managing workloads in a database system.

### BACKGROUND

Relational database systems store data in tables organized by columns and rows. The tables are typically linked together by “relationships” that simplify the storage of data and make complex queries of the data more efficient. Structured Query Language (SQL) is a standardized language for creating and interacting with relational databases.

Relational databases are typically managed using a database management system (DBMS) which often comprises a suite of software programs to control organisation, storage and retrieval of data in the database.

As database management systems continue to increase in function and expand into new application areas, the diversity of database workloads also increases. In particular, in view of new complex data types such as images, audio and video, and new active data warehouse requirements such as capacity on demand, data replication, fault tolerance, dual active query processing, recursion, user defined types and external UDFs, widely varying memory, processor, disk and network demands are increasingly expected to be placed on database systems.

Optimizing database performance to cope with such increasing demands is difficult because workloads often interfere with each others performance through competition for shared resources. For example, optimization of one database setting may improve the performance goal of one workload but may hamper the performance goal of another workload.

### SUMMARY OF THE INVENTION

In accordance with a first aspect of the present invention there is provided a system for managing database workloads, said system comprising:

a historical data collector arranged to collect historical data indicative of historical database performance trends; and

a current data collector arranged to collect substantially current data indicative of substantially current database performance;

the system being arranged to compare the collected historical data with the collected substantially current data and to modify operation of the database based on the comparison.

The system may be arranged to modify database settings based on the comparison and/or carry out a database action based on the comparison.

In one arrangement, the database settings modifiable by the system comprise system resource settings including database throttles, database filters and/or resource weights of one or more workloads.

In one arrangement, the database actions which may be carried out by the system comprise sending a communication to a database administrator (DBA), or aborting a query.

In one arrangement, the system is arranged to store the collected historical data in summary tables.

In one embodiment, the historical data collector is arranged to collect a plurality of historical data value types. The historical data value types may be a System CPU value, an Active Session value, a CPU Usage by Workload value, a Spool Usage value, a Number of Queries Submitted value, a System CPU Trend value, a CPU Growth Trend by Workload Definition value, a Query Growth Trend by Workload Definition value, a CPU Time per Query by Workload Definition or a Disk Throughput value.

In one embodiment, the system is arranged to modify database operation based on historical data collected from a plurality of data value types.

In one embodiment, the system is arranged to generate a threshold value for each collected historical value, and to modify one or more database settings only when the collected substantially current value exceeds or is less than the threshold value. The threshold value may be set at a predetermined level relative to an average value of the collected historical value, such as 15% above or below the average value.

The system may be separate to or wholly or partly incorporated into a database management system (DBMS).

In one arrangement, the system is arranged to communicate with a Resource Sampling SubSystem (RSS) used in a Teradata Active Data Warehousing System available from NCR Corporation, and with a Database Query Log (DBQL) subsystem to collect historical resource usage data and historical DBQL data respectfully from the database.

The system may be arranged to compare collected historical data with collected substantially current data using statistical algorithms, such as statistical process control algorithms, OLAP functions, or heuristics.

In accordance with a second aspect of the present invention, there is provided a method of managing database workloads, said method comprising:

collecting historical data indicative of historical database performance trends;

collecting current data indicative of substantially current database performance;

comparing the collected historical data with the collected substantially current data; and

modifying operation of the database based on the comparison.

The method may further comprise modifying database settings based on the comparison and/or carrying out a database action based on the comparison.

In one arrangement, the modifiable database settings comprise system resource settings including database throttles, database filters and/or resource weights of one or more workloads.

In one arrangement, the database actions comprise sending a communication to a database administrator (DBA), or aborting a query.

The method may further comprise storing the collected historical data in summary tables.

The step of collecting historical data may comprise collecting a plurality of historical data value types.

The historical data value types may be a System CPU value, an Active Session value, a CPU Usage by Workload value, a Spool Usage value, a Number of Queries Submitted value, a System CPU Trend value, a CPU Growth Trend by Workload Definition value, a Query Growth Trend by Workload Definition value, a CPU Time per Query by Workload Definition or a Disk Throughput value.

In one embodiment, the system is arranged to modify database operation based on historical data collected from a plurality of data value types.

The method may further comprise generating a threshold value for each collected historical value, and modifying one or more database settings only when the collected substantially current value exceeds or is less than the threshold value. The threshold value may be set at a predetermined level relative to an average value of the collected historical value, such as 15% above or below the average value.

The method may further comprise communicatng with a RSS subsystem and a Database Query Log (DBQL) subsystem to collect historical resource usage data and historical DBQL data respectfully from the database.

In accordance with a third aspect of the present invention, there is provided a computer program arranged when loaded into a computer to instruct the computer to operate in accordance with a system for managing database workloads, said system comprising:

a historical data collector arranged to collect historical data indicative of historical database performance trends; and

a current data collector arranged to collect substantially current data indicative of substantially current database performance;

the system being arranged to compare the collected historical data with the collected substantially current data and to modify operation of the database based on the comparison.

### BRIEF DESCRIPTION OF THE DRAWINGS

The present invention will now be described, by way of example only, with reference to the accompanying drawings, in which:

FIG. 1 is a schematic block diagram of a node of a database system;

FIG. 2 is a schematic block diagram of a parsing engine of the database system node shown in FIG. 1;

FIG. 3 is a schematic block diagram of a parser of the parsing engine shown in FIG. 2;

FIG. 4 is a schematic block diagram of a system for managing workloads in a database system in accordance with an embodiment of the present invention;

FIG. 5 is a schematic block diagram of an administrator of the system shown in FIG. 4;

FIG. 6 is a schematic block diagram of a regulator of the system shown in FIG. 4;

FIG. 7 is a schematic block diagram of workload query delay manager of the system shown in FIG. 4;

FIG. 8 is a schematic block diagram of an exception monitor of the system shown in FIG. 4;

FIG. 9 is a flow diagram illustrating a method of managing workloads in a database system in accordance with an embodiment of the present invention;

FIG. 10 is a chart illustrating a data model representing historical and real time CPU usage of the system shown in FIG. 4; and

FIG. 11 is a chart illustrating variance of current CPU utilization compared to average historical CPU utilization according to the chart shown in FIG. 10.

### DETAILED DESCRIPTION

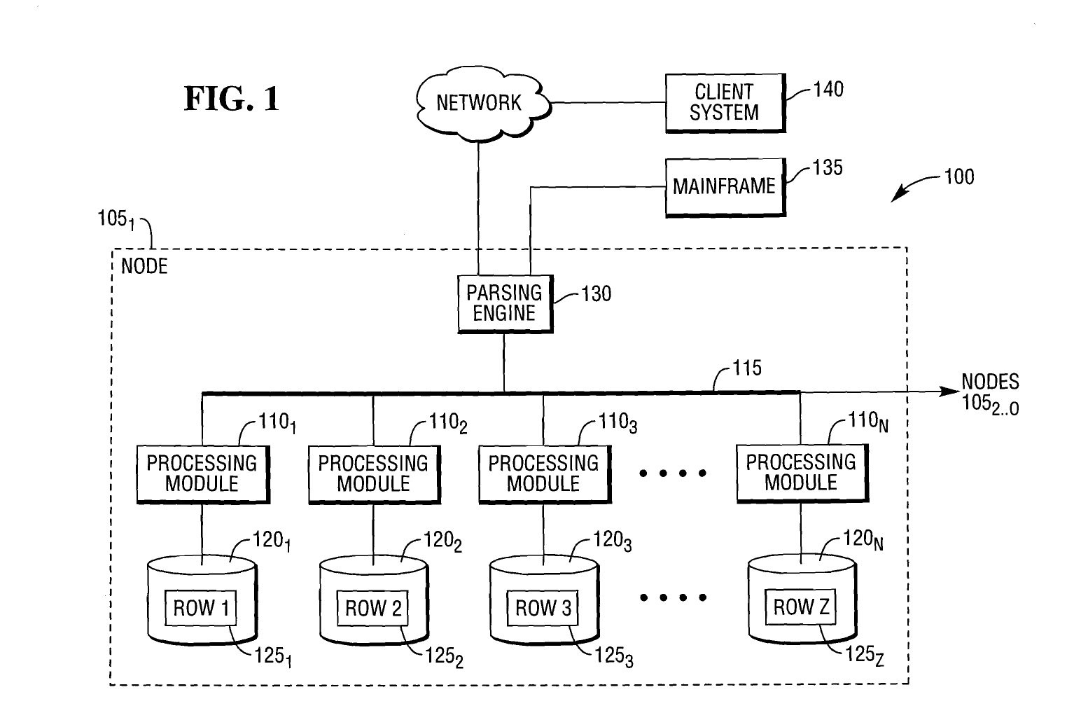

The workload management system disclosed herein has particular application, but is not limited, to large databases capable of containing millions of records managed by a database management system (“DBMS”) 100, such as a Teradata Active Data Warehousing System available from NCR Corporation. FIG. 1 shows a sample DBMS architecture for one node 105₁ of the DBMS 100. The DBMS node 105₁ includes one or more processing modules 110_{1 . . . N}, connected by a network 115, that manage the storage and retrieval of data in data-storage facilities 120_{1 . . . N}. Each of the processing modules 110_{1 . . . N} may be one or more physical processors or each may be a virtual processor, with one or more virtual processors running on one or more physical processors.

For the case in which one or more virtual processors are running on a single physical processor, the single physical processor swaps between the set of N virtual processors.

For the case in which N virtual processors are running on an M-processor node, the node's operating system schedules the N virtual processors to run on its set of M physical processors. If there are 4 virtual processors and 4 physical processors, then typically each virtual processor would run on its own physical processor. If there are 8 virtual processors and 4 physical processors, the operating system would schedule the 8 virtual processors against the 4 physical processors, in which case swapping of the virtual processors would occur.

Each of the processing modules 110_{1 . . . N} manages a portion of a database that is stored in a corresponding one of the data-storage facilities 120_{1 . . . N}. Each of the data-storage facilities 120_{1 . . . N} includes one or more disk drives. The DBMS may include multiple nodes 105_{2 . . . O} in addition to the illustrated node 105₁, connected by extending the network 115.

The system stores data in one or more tables in the data-storage facilities 120_{1 . . . N}. Rows 125_{1 . . . Z} of the tables are stored across multiple data-storage facilities 120_{1 . . . N} to ensure that the system workload is distributed evenly across the processing modules 110_{1 . . . N}. A parsing engine 130 organizes the storage of data and the distribution of table rows 125_{1 . . . Z} among the processing modules 110_{1 . . . N}. The parsing engine 130 also coordinates the retrieval of data from the data-storage facilities 120_{1 . . . N} in response to queries received from a user at a mainframe 135 or a client computer 140. The DBMS 100 usually receives queries and commands to build tables in a standard format, such as SQL.

In one implementation, the rows 125_{1 . . . Z} are distributed across the data-storage facilities 120_{1 . . . N} by the parsing engine 130 in accordance with their associated primary index. The primary index defines the columns of the rows that are used for calculating a hash value. The function that produces the hash value from the values in the columns specified by the primary index is called the hash function. Some portion, possibly the entirety, of the hash value is designated a “hash bucket”. The hash buckets are assigned to data-storage facilities 120_{1 . . . N} and associated processing modules 110_{1 . . . N} by a hash bucket map. The characteristics of the columns chosen for the primary index determine how evenly the rows are distributed.

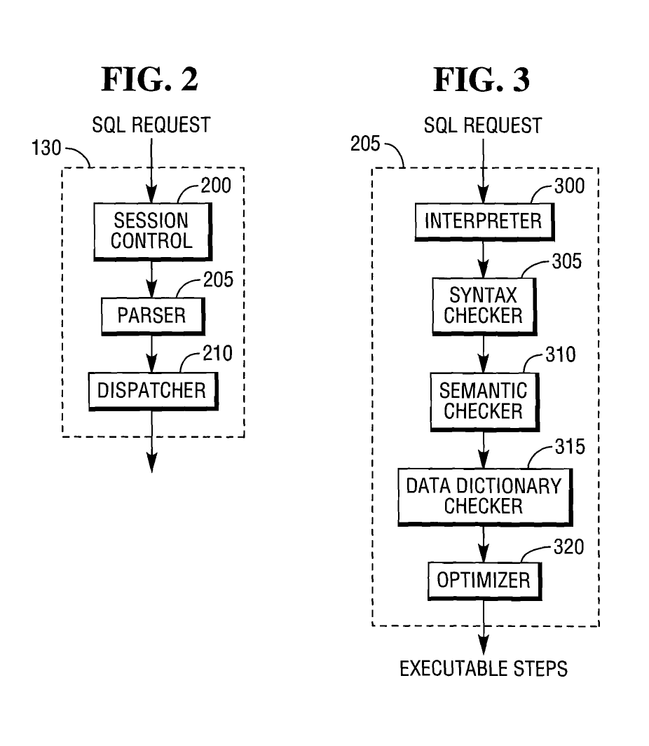

In one example system, the parsing engine 130 is made up of three components: a session control 200, a parser 205, and a dispatcher 210, as shown in FIG. 2. The session control 200 provides the logon and logoff function. It accepts a request for authorization to access the database, verifies it, and then either allows or disallows the access.

Once the session control 200 allows a session to begin, a user may submit a SQL request, which is routed to the parser 205. As illustrated in FIG. 3, the parser 205 interprets the SQL request 300, checks it for proper SQL syntax 305, evaluates it semantically 310, and consults a data dictionary to ensure that all of the objects specified in the SQL request actually exist and that the user has the authority to perform the request 315. Finally, the parser 205 runs an optimizer 320, which generates the least expensive plan to perform the request.

The requirements arising from diverse workloads necessitates a different mechanism for managing the system workload. Specifically, it is desired to dynamically adjust resources (e.g. CPU, disk I/O, BYNET (which is NCR's term for the network 115), memory, sessions, etc.) in order to achieve a set of per-workload response time goals for complex “multi-class” workloads. In this context, a “workload” is a set of requests, which may include queries or utilities, such as loads, that have some common characteristics, such as application, source of request, type of query, priority, response time goals, etc., and a “multi-class workload” is an environment with more than one workload. Automatically managing and adjusting database management system (DBMS) resources (tasks, queues, CPU, memory, memory cache, disk, network, etc.) in order to achieve a set of per-workload response time goals for a complex multi-class workload is challenging because of the inter-dependence between workloads that results from their competition for shared resources.

The DBMS 100 described herein dynamically adjusts its own performance knobs, such as by allocating DBMS resources and throttling back incoming work. In one example system, the performance knobs are called priority scheduler knobs. When the priority scheduler knobs are adjusted, weights assigned to resource partitions and allocation groups are changed. Adjusting how these weights are assigned modifies the way access to the CPU, disk and memory is allocated among requests. Given performance objectives for each workload and the fact that the workloads may interfere with each other's performance through competition for shared resources, the DBMS may find a performance knob setting that achieves one workload's goal but makes it difficult to achieve another workload's goal.

The performance goals for each workload will vary widely as well, and may or may not be related to their resource demands. For example, two workloads that execute the same application and DBMS code could have differing performance goals simply because they were submitted from different departments in an organization. Conversely, even though two workloads have similar performance objectives, they may have very different resource demands.

One solution to the problem of automatically satisfying all workload performance goals is to use more than one mechanism to manage system workload. This is because each class can have different resource consumption patterns, which means the most effective knob for controlling performance may be different for each workload. Manually managing the knobs for each workload becomes increasingly impractical as the workloads become more complex. Even if the DBMS can determine which knobs to adjust, it must still decide in which dimension and how far each one should be turned. In other words, the DBMS must translate a performance goal specification into a particular resource allocation that will achieve that goal.

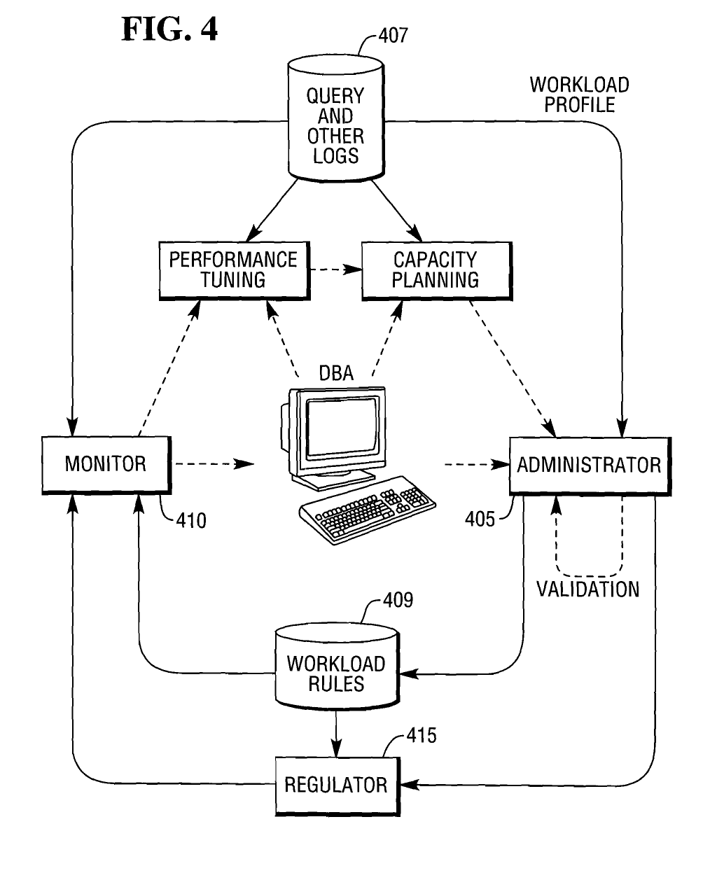

A system 400 for managing workloads in a database system is shown in FIG. 4. The system 400 comprises the following components:
1) Administrator 405: This component provides a GUI to define workloads and their SLGs and other workload management requirements. The administrator 405 accesses data in logs 407 associated with the system, including a query log, and receives capacity planning and performance tuning inputs. The administrator 405 is a primary interface for the DBA. The administrator also establishes workload rules 409, which are accessed and used by other elements of the system.
2) Monitor 410: This component provides a top level dashboard view and the ability to drill down to various details of workload group performance such as aggregate execution time, execution time by request, aggregate resource consumption, resource consumption by request, etc. Such data is stored in the query log and other logs 407 available to the monitor. The monitor also includes processes that initiate the performance improvement mechanisms listed above and processes that provide long term trend reporting, which may include providing performance improvement recommendations. Some of the monitor functionality may be performed by a regulator described below.
3) Regulator 415: This component dynamically adjusts system settings and/or projects performance issues and either alerts the database administrator (DBA) or user to take action, for example, by communication through the monitor, which is capable of providing alerts, or through the exception log, providing a way for applications and their users to become aware of, and take action on, regulator actions. Alternatively, the regulator can automatically take action by deferring requests or executing requests with the appropriate priority to yield the best solution given requirements defined by the administrator 405.

The workload management administrator 405, or “administrator,” is responsible for determining (i.e., recommending) the appropriate application settings based on SLGs. Such activities as setting weights, managing active work tasks and changes to any and all options will be automatic and taken out of the hands of the DBA. The user will be masked from all complexity involved in setting up the priority scheduler, and be freed to address the business issues around it.

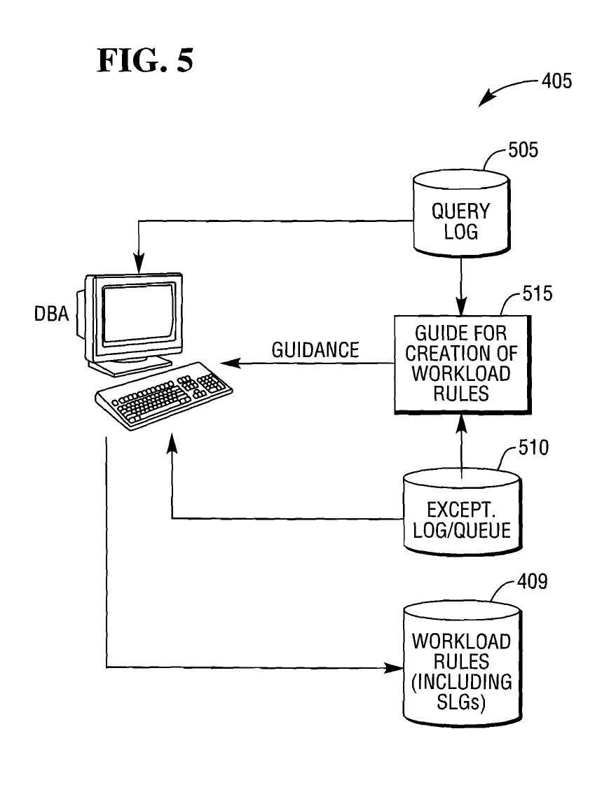

As shown in FIG. 5, the workload management administrator 405 allows the DBA to establish workload rules, including SLGs, which are stored in a storage facility 409, accessible to the other components of the system. The DBA has access to a query log 505, which stores the steps (i.e. requests) performed by the DBMS in executing a request along with database statistics associated with the various steps, and an exception log/queue 510, which contains records of the system's deviations from the SLGs established by the administrator. With these resources, the DBA can examine past performance and establish SLGs that are reasonable in light of the available system resources. In addition, the system provides a guide 515 for creation of workload rules which guides the DBA in establishing the workload rules 409. The guide 515 accesses the query log 505 and the exception log/queue 510 in providing its guidance to the DBA.

The administrator 405 assists the DBA in:
a) Establishing rules for dividing requests into candidate workload groups, and creating workload group definitions. Requests with similar characteristics (users, application, table, resource requirement, etc.) are assigned to the same workload group. The system supports the possibility of having more than one workload group with similar system response requirements.
b) Refining the workload group definitions and defining SLGs for each workload group. The system provides guidance to the DBA for response time and/or arrival rate threshold setting by summarizing response time and arrival rate history per workload group definition versus resource utilization levels, which it extracts from the query log (from data stored by the regulator, as described below), allowing the DBA to know the current response time and arrival rate patterns. The DBA can then cross-compare those patterns to satisfaction levels or business requirements, if known, to derive an appropriate response time and arrival rate threshold setting, i.e., an appropriate SLG. After the administrator specifies the SLGs, the system automatically generates the appropriate resource allocation settings, as described below. These SLG requirements are distributed to the rest of the system as workload rules.
c) Optionally, establishing priority classes and assigning workload groups to the classes. Workload groups with similar performance requirements are assigned to the same class.
d) Providing proactive feedback (i.e.: Validation) to the DBA regarding the workload groups and their SLG assignments prior to execution to better assure that the current assignments can be met, i.e., that the SLG assignments as defined and potentially modified by the DBA represent realistic goals. The DBA has the option to refine workload group definitions and SLG assignments as a result of that feedback.

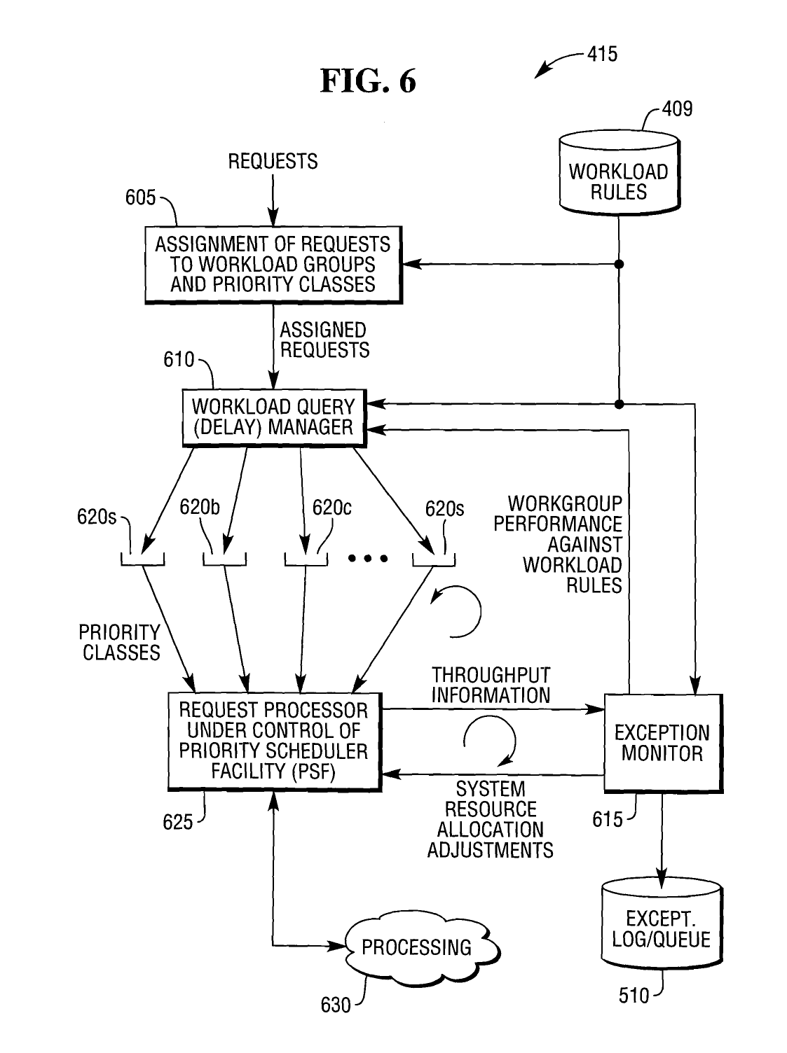

The regulator 415 illustrated in more detail in FIG. 6 accomplishes its objective by dynamically monitoring and adjusting the workload characteristics based on comparisons between historical workload data and current workload data.

Prior to query execution, an incoming request is examined to determine in which workload group it belongs. Concurrency levels, i.e., the numbers of concurrent executing queries from each workload group, are monitored, and if current workload group concurrency levels are above an administrator-defined threshold, a request in that workload group waits in a queue prior to execution until the concurrency level subsides below the defined threshold. Query execution requests currently being executed are monitored to determine if they still meet the criteria of belonging in a particular workload group by comparing request execution characteristics to a set of exception conditions. If the result suggests that a request violates the rules associated with a workload group, an action is taken to move the request to another workload group or to abort it, and/or alert on or log the situation with potential follow-up actions as a result of detecting the situation.

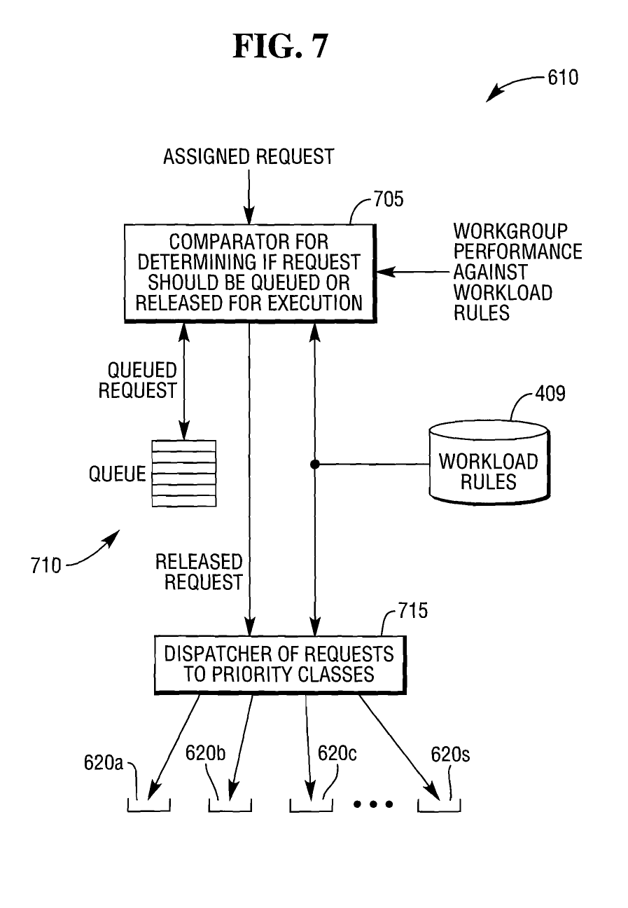

As shown in FIG. 6, the regulator 415 receives one or more requests, each of which is assigned by an assignment process 605 to a workload group and, optionally, a priority class, in accordance with the workload rules 409. The assigned requests are passed to a workload query (delay) manager 610, which is described in more detail with respect to FIG. 7. In general, the workload query (delay) manager monitors the workload performance compared to the workload rules and either allows the request to be executed immediately or holds it for later execution, as described below. If the request is to be executed immediately, the workload query (delay) manager 610 places the request in the priority class bucket 620a . . . s corresponding to the priority class to which the request was assigned by the administrator 405. A request processor under control of a priority scheduler facility (PSF) 625 selects queries from the priority class buckets 620a . . . s, in an order determined by the priority associated with each of the buckets, and executes it, as represented by the processing block 630 in FIG. 6.

The request processor 625 also monitors the request processing and reports throughput information, for example, for each request and for each workgroup, to an exception monitoring process 615. The exception monitoring process 615 compares the throughput with the historical throughput data and stores any exceptions in the exception log/queue. In addition, the exception monitoring process 615 provides system resource allocation adjustments to the request processor 625, which adjusts system resource allocation accordingly, e.g., by adjusting the priority scheduler weights. Further, the exception monitoring process 615 provides data regarding the workgroup performance against historical workloads to the workload query (delay) manager 610, which uses the data to determine whether to delay incoming requests, depending on the workload group to which the request is assigned.

The workload query (delay) manager 610, shown in greater detail in FIG. 7, receives an assigned request as an input. A comparator 705 determines if the request should be queued or released for execution. It does this by determining the workload group assignment for the request and comparing that workload group's performance against the workload rules, provided by the exception monitoring process 615. For example, the comparator 705 may examine the concurrency level of requests being executed under the workload group to which the request is assigned. Further, the comparator may compare the workload group's performance against other workload rules.

If the comparator 705 determines that the request should not be executed, it places the request in a queue 710 along with any other requests for which execution has been delayed. The comparator 705 continues to monitor the workgroup's performance against the workload rules and when it reaches an acceptable level, it extracts the request from the queue 710 and releases the request for execution. In some cases, it is not necessary for the request to be stored in the queue to wait for workgroup performance to reach a particular level, in which case it is released immediately for execution.

Once a request is released for execution it is dispatched 715 to priority class buckets 620a . . . s, where it will await retrieval by the request processor 625.

The system 400 enables service level goals to be achieved across multiple workloads by managing performance objectives across the entire database domain. This is achieved by collecting historical trend data, comparing the trend data with real time resource usage data and modifying one or more database settings or carrying out other database actions based on the comparison.

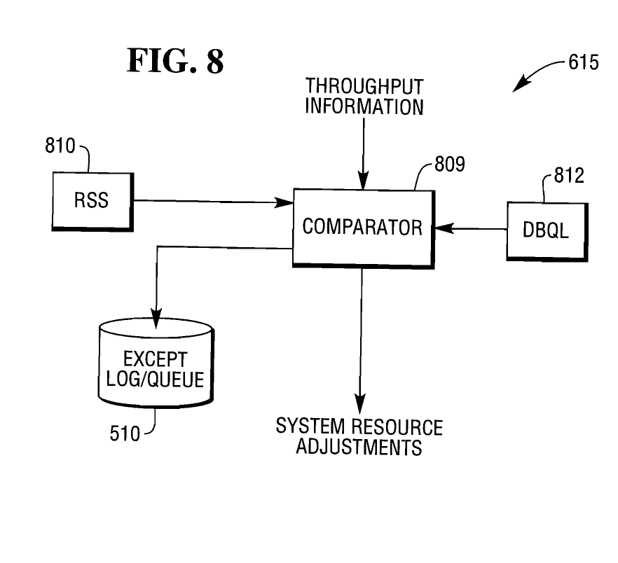

The exception monitor illustrated in FIG. 8 collects historical trend data and real time workload performance data and a workload comparator 809 compares the collected historical data with the real time data in order to determine whether modification of one or more database settings and/or other database actions are required. Any deviations are logged in the exception log/queue 510. The exception monitor 615 uses a RSS subsystem 810 and a Database Query Log (DBQL) subsystem 812 to collect historical resource usage data and historical DBQL data respectively.

The system 400 also comprises a memory (not shown) which may be in the form of Cache memory, the memory serving to store the collected historical data and action rules which are used by the regulator 415 to determine when a database setting is to be modified, which setting to is to be modified and/or when other actions based on a comparison of real time resource usage and historical resource usage are to be carried out.

In the present example, the regulator 415 in association with the RSS and DBQL subsystems 810, 812 is capable of collecting historical data by system, node, vproc, workload, query or account, and in this example the collected historical data is collated into summary tables at user specified intervals and data models are built from the tables.

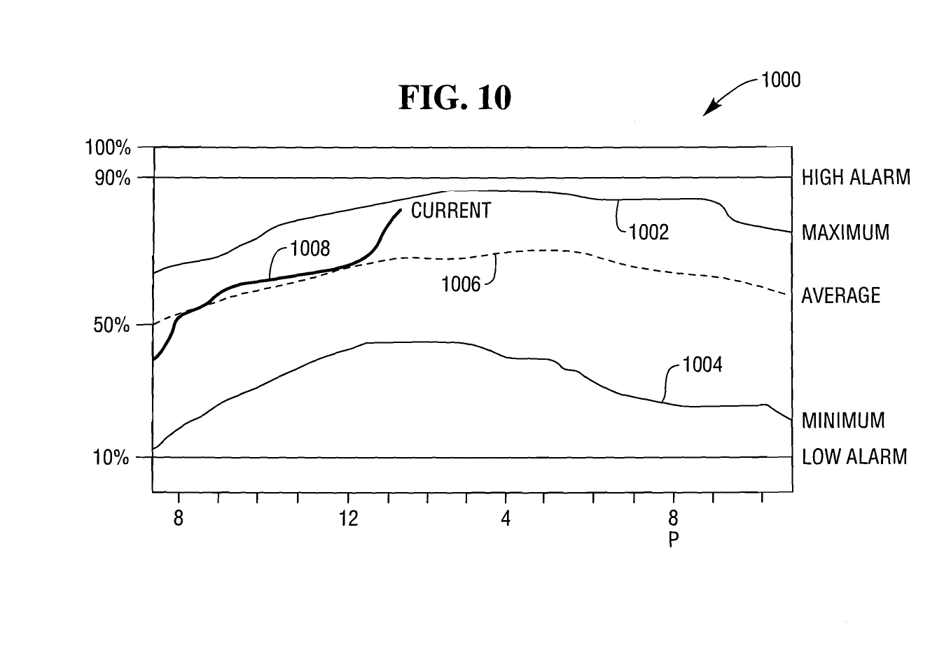

For example, as shown in FIG. 10, a data model 1000 showing CPU utilization for the last 5 Tuesdays is shown. The model 1000 illustrates maximum 1002 and minimum 1004 historical values and a historical average CPU usage value 1006 between 7.30 am and 10.30 pm. The model 1000 also shows the current CPU usage value 1008 superimposed over the historical values.

In the present example, multiple models based on multiple collected values are obtained. The values can be monitored based on the rules stored in the memory which may be predefined rules or user definable rules. Various types of trend data values may be collected, including:

System CPU

This value indicates how busy the or each system processor is and therefore whether the processor has the capacity to do more work. The value can be monitored according to any suitable time frame. For example, the CPU value may be monitored from 8.00 am to the current time, or over a longer period of time such as a week or a month, and so on.

Active Sessions

This value corresponds to the number of currently active sessions by workload. Since the response time of a query is directly affected by the time sharing of the system CPU amongst all active sessions, this value gives an indication as to expected response time.

CPU Usage by Workload, Users, Account or Application

This value corresponds to CPU usage broken down into workload, user, account and/or application for a chosen time period. The value is indicative of heavy users or users with a high CPU skew, and users with runaway queries.

Spool Usage

This value can be used to indicate the usage of a spool and help identify user's queries which may require some tuning or collection of up to date statistics. The value can also be used to show the total spool by all users at a specific instance in time.

Number of Queries Submitted

This value indicates the average number of requests processed per minute as well as the average response time.

System CPU Trend

This value indicates the rate of growth of CPU usage and is used to focus on a daytime shift of a nighttime shift depending on which shift is the primary bottleneck.

CPU Growth Trend by Workload Definition

This value shows growth of CPU usage by workload definition.

Query Growth Trend by Workload Definition

This value shows rate of growth of the number of queries by workload definition.

CPU Time per Query by Workload Definition

This value can be used for capacity planning purposes. The average CPU time per query by different workloads can be used to project how much additional resources will be consumed when additional users and queries are planned for an existing workload definition. Also, for new workloads that can be considered to be similar to an existing workload definition, the average time can be used to approximate the resources that are expected to be used by the new workload.

Disc Throughput

This value is indicative of the actual physical disc I/O compared with the physical capacity that the system can produce.

A database setting may be modified and/or a database action may be instigated on the basis of the predefined rules stored in the memory. In the present example, based on the collected historical data values, a threshold value is defined for each collected value and a setting modified or an action carried out when the corresponding current value exceeds or falls below the threshold value.

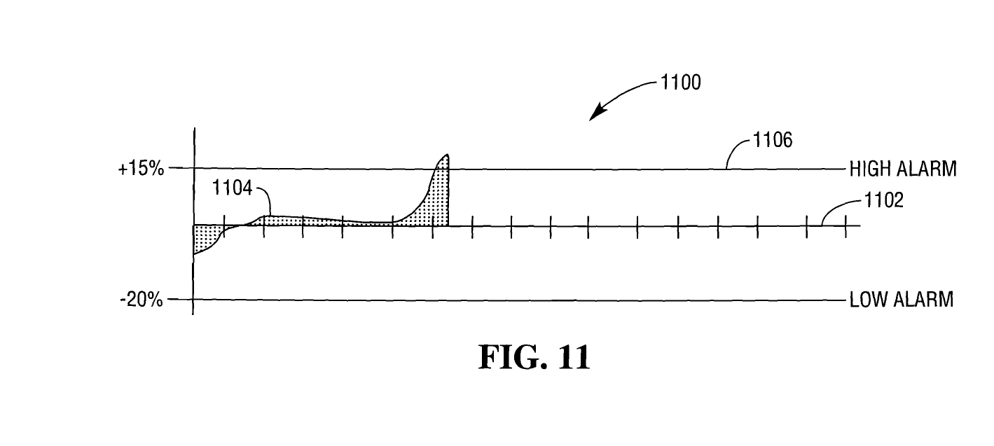

For example, with the example shown in FIG. 10 which relates to a CPU usage value, a threshold which corresponds to 15% above the average historical value is defined. This is shown more particularly in the variance model 1100 in FIG. 11 which shows an average historical value 1102, the variance 1104 from the average value and a threshold level 1106. As can be seen, at around 1 pm the current value 1104 exceeded the threshold level 1106 and, accordingly, at this instance a database setting would be modified and/or a database action would be carried out in an attempt to overcome the problem.

The appropriate setting to modify and/or the appropriate action to carry out may depend on one or more of the monitored vales which may be combined in accordance with predefined rules.

In one example, the system 400 first determines whether a problem exists with response time goals by comparing historical response times with current response times. If the current response time is below a predetermined historical response time threshold, the system CPU busy value is analyzed. If the system CPU is not at 100% busy and does not have heavy skewing, the Active Session value is analyzed to check for blocked sessions. If the number of active sessions is outside of the predefined Active Session threshold limit, then appropriate dynamic controls are applied to limit or abort queries, or adjustments are made to the priority schedule weights. If the CPU is 100% busy, the CPU Growth Trend by Workload Definition value is checked to see if there is a runaway query. If a runaway query is detected, an appropriate action can be taken such as to abort the runaway query.

It will be understood that various database settings may be modified in response to the comparisons of the historical data values with corresponding real time data values, including modifying system resource settings by adjusting throttles, filters, resource weights of one or more workloads, or any other modifiable database setting which affects database operation.

Database actions carried out in response to the comparisons of the historical data values with corresponding real time data values include alerting the DBA, or any other suitable action.

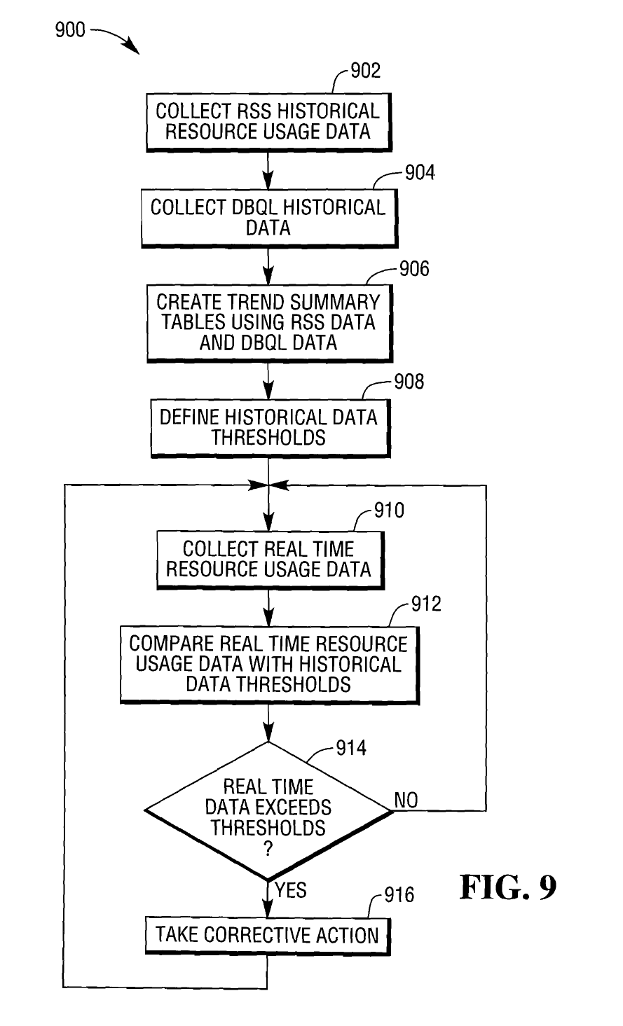

An example method of managing workloads in a database system is illustrated by the flow diagram 900 in FIG. 9. The flow diagram shows steps 902-916 of an example wherein corrective action is carried out on database workflows based on comparisons of trend historical data and real time usage data.

Modifications and variations as would be apparent to a skilled addressee are deemed to be within the scope of the present invention.

1. A system for managing database workloads, said workload managing system comprising:
a historical data collector arranged to collect historical data indicative of historical database performance trends; and
a current data collector arranged to collect substantially current data indicative of substantially current database performance;
the system being arranged to compare the collected historical data with the collected substantially current data and to modify operation of the database based on the comparison.

2. A system as claimed in claim 1, wherein the system is arranged to modify database settings based on the comparison.

3. A system as claimed in claim 1, wherein the system is arranged to carry out a database action based on the comparison.

4. A system as claimed in claim 2, wherein the database settings modifiable by the system comprise database resource settings.

5. A system as claimed in claim 4, wherein the database resource settings include database throttles, database filters and/or resource weights of one or more workloads.

6. A system as claimed in claim 3, wherein database actions which may be carried out by the system comprise sending a communication to a database administrator (DBA), or aborting a query.

7. A system as claimed in claim 1, wherein the system is arranged to store the collected historical data in summary tables.

8. A system as claimed in claim 1, wherein the historical data corresponds to a System CPU value, an Active Session value, a CPU Usage by Workload value, a Spool Usage value, a Number of Queries Submitted value, a System CPU Trend value, a CPU Growth Trend by Workload Definition value, a Query Growth Trend by Workload Definition value, a CPU Time per Query by Workload Definition or a Disk Throughput value.

9. A system as claimed in claim 1, wherein the historical data collector is arranged to collect a plurality of historical data value types.

10. A system as claimed in claim 9, wherein the system is arranged to modify database operation based on historical data collected from the plurality of data value types.

11. A system as claimed in claim 1, wherein the system is arranged to generate a threshold value for each collected historical value, and to modify one or more database settings only when the collected substantially current value exceeds or is less than the threshold value.

12. A system as claimed in claim 11, wherein the threshold value is set at a predetermined level relative to an average value of the collected historical value.

13. A system as claimed in claim 12, wherein the predetermined level is 15% above or below the average collected historical value.

14. A system as claimed in claim 1, wherein the system is arranged to communicate with a RSS subsystem and a Database Query Log (DBQL) subsystem to collect historical resource usage data and historical DBQL data respectfully from the database.

15. A method of managing database workloads, said method comprising:
collecting historical data indicative of historical database performance trends;
collecting current data indicative of substantially current database performance;
comparing the collected historical data with the collected substantially current data; and
modifying operation of the database based on the comparison.

16. A method as claimed in claim 15, further comprising modifying database settings based on the comparison.

17. A method as claimed in claim 15, further comprising carrying out a database action based on the comparison.

18. A method as claimed in claim 16, further comprising modifying database throttles, database filters and/or resource weights of one or more workloads based on the comparison.

19. A method as claimed in claim 17, further comprising sending a communication to a database administrator (DBA), or aborting a query based on the comparison.

20. A method as claimed in claim 15 further comprising storing the collected historical data in summary tables.

21. A method as claimed in claim 15, wherein the step of collecting historical data comprises collecting a plurality of historical data value types.

22. A method as claimed in claim 21, further comprising modifying database operation based on historical data collected from a plurality of data value types.

23. A method as claimed in claim 15, wherein the historical data value types comprise a System CPU value, an Active Session value, a CPU Usage by Workload value, a Spool Usage value, a Number of Queries Submitted value, a System CPU Trend value, a CPU Growth Trend by Workload Definition value, a Query Growth Trend by Workload Definition value, a CPU Time per Query by Workload Definition or a Disk Throughput value.

24. A method as claimed in claim 15, further comprising generating a threshold value for each collected historical value, and modifying one or more database settings only when the collected substantially current value exceeds or is less than the threshold value.

25. A method as claimed in claim 24, further comprising setting the threshold value at a predetermined level relative to an average value of the collected historical value.

26. A method as claimed in claim 25, wherein the threshold value is set at 15% above or below the average historical data value.

27. A computer program arranged when loaded into a computer to instruct the computer to operate in accordance with a system for managing database workloads, said workload managing system comprising:
a historical data collector arranged to collect historical data indicative of historical database performance trends;
a current data collector arranged to collect substantially current data indicative of substantially current database performance; and
the system being arranged to compare the collected historical data with the collected substantially current data and to modify operation of the database based on the comparison.
